(19) United States
(12) Patent Application Publication
(10) Pub. No.: US 2006/0130540 A1
(43) Pub. Date: Jun. 22, 2006

(54) Padlock having dual unlocking modes

(76) Inventor: Pai-Chang Lin, Chung-Ho city (TW)

Correspondence Address: RABIN & Berdo, PC, 1101 14TH STREET, NW, SUITE 500, WASHINGTON, DC, 20005, US

(21) Appl. No.: 11/312,396

(22) Filed: Dec. 21, 2005

(30) Foreign Application Priority Data
Dec. 22, 2004 (TW) 93139972

(51) Int. Cl. E05B 37/02

(52) U.S. Cl. 70/21

(57) ABSTRACT

A padlock having dual unlocking modes includes a body having a movable arm, at least one dialing wheel pivotally coupled on the body, a cam rotated by the rotation of the dialing wheel, a holding plate pressing against the dialing wheel, an elastic element for driving the holding plate in contact with the cam, a lock member being adapted to pressed by the holding plate, and a lock cylinder having an actuation member. The lock member may be driven by the holding plate or by the lock cylinder turned by k key, wherein the lock member may be at a first position interfering with the movement of movable arm or be at a second position without interfering with the movement of the movable arm.

### CROSS-REFERENCE TO RELATED APPLICATIONS

This non-provisional application claims priority under 35 U.S.C. § 119(a) on Patent Application No(s). 93139972 filed in Taiwan, R.O.C. on Dec. 22, 2004 the entire contents of which are hereby incorporated by reference.

### FIELD OF THE INVENTION

The present invention relates to a padlock mechanism having dual unlocking modes and particularly to a padlock that may be operated by setting a combination or by inserting and turning a key.

### BACKGROUND OF THE INVENTION

Padlocks are widely used on articles that have obvious or potential security concerns. The conventional padlocks include key locks that are locked and unlocked by inserting and turning a key and combination locks that are locked and unlocked by setting a combination. The key locks have the advantage of preventing the combination from being decoded, while the combination locks have the convenience of using without a key.

In practice, a lock equipped with the design of dual unlocking modes enables users to select either way to unlock according to use requirements. For instance, when a user forgets to carry the key or the combination, he/she can choose another way to unlock. In addition, the lock, having dual unlocking modes, allows two different users or groups to use the same lock. For instance, a security lock to be used in the airport or school can be set, so the general users or students have to set a valid combination to unlock while the key is kept only by the security people or managers.

### SUMMARY OF THE INVENTION

In view of requirements for the padlocks having dual unlocking modes, the object of the invention is to provide a padlock that has dual unlocking modes by setting a combination and using a key, so that users can select either way to unlock according to different requirements.

The padlock according to the invention includes a body, at least one dialing wheel, a cam, a holding plate, an elastic element, a lock member, and a lock cylinder.

The body has a movable arm, and the dialing wheel is pivotally coupled on the body. The cam is selectively rotated by the rotation of the dialing wheel. The holding plate presses against the dialing wheel, and is selectively at a protruding position or a contacting position according to the rotation of the cam, wherein the elastic element is for driving the holding plate in contact with the cam;

The lock member is adapted to be pressed by the holding plate. As the holding plate is at the protruding position, the lock member is at a first position interfering with the movement of the movable arm. And, as the holding plate is at the contacting position, the lock member is at a second position without interfering with the movement of the movable arm.

The lock cylinder may be turned by a key and has an actuation member, wherein the lock cylinder is movable for driving the lock member through the actuation member to drive the lock member to switch between the first position and the second position. So that the lock member is at the first position interfering with the movement of the movable arm, or is at a second position without interfering with the movement of the movable arm.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the padlock of the invention;

FIG. 2 is a perspective view of the padlock of the invention with a side cap separated;

FIG. 3 is a perspective view of the structure inside the padlock of the invention;

FIG. 4 is a plane view of the padlock of the invention showing a combination lock mechanism in an unlocked condition;

FIG. 5 is a plane view of the padlock of the invention showing the combination lock mechanism in a locked condition;

FIG. 6 is a plane view of the padlock of the invention showing the combination lock mechanism in an unlocked condition and a key inserting in a lock cylinder;

FIG. 7 is a plane view of the padlock of the invention showing the combination lock mechanism in an unlocked condition and the lock cylinder being turned by the key; and

FIGS. 8 and 9 are schematic views of the invention showing a driving mechanism between the lock cylinder and the lock member.

### DESCRIPTION OF THE PREFERRED EMBODIMENTS

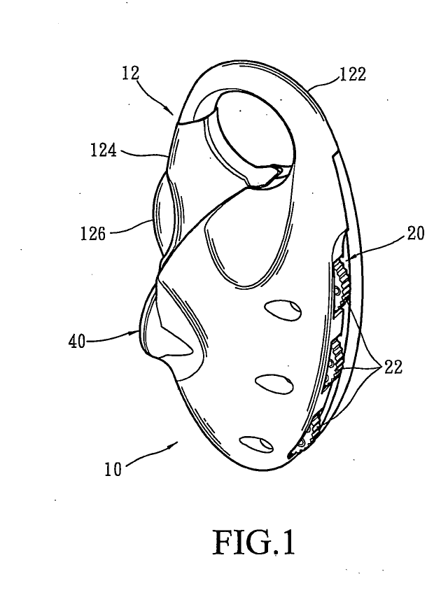

FIG. 1 shows an embodiment of the padlock having dual unlocking modes of the invention. The padlock includes a body 10, which has a shackle 12 on an upper end to form a closed space. The shackle 12 has a fixed portion 122 fastened to the body 10 and a movable arm 124 pivotally coupled on the body 10 acting as a driven element. The movable arm 124 is coupled with a depressing section 126, which receives an external force to drive the movable arm 124 to a position to form a notch on the shackle 12.

In this embodiment, the movable arm 124 is a driven element and able to be interfered by the lock mechanism of the padlock. The movable arm 124 is pressed by a first elastic element 128 located in the body 10, to keep the shackle 12 in a closed status in normal condition.

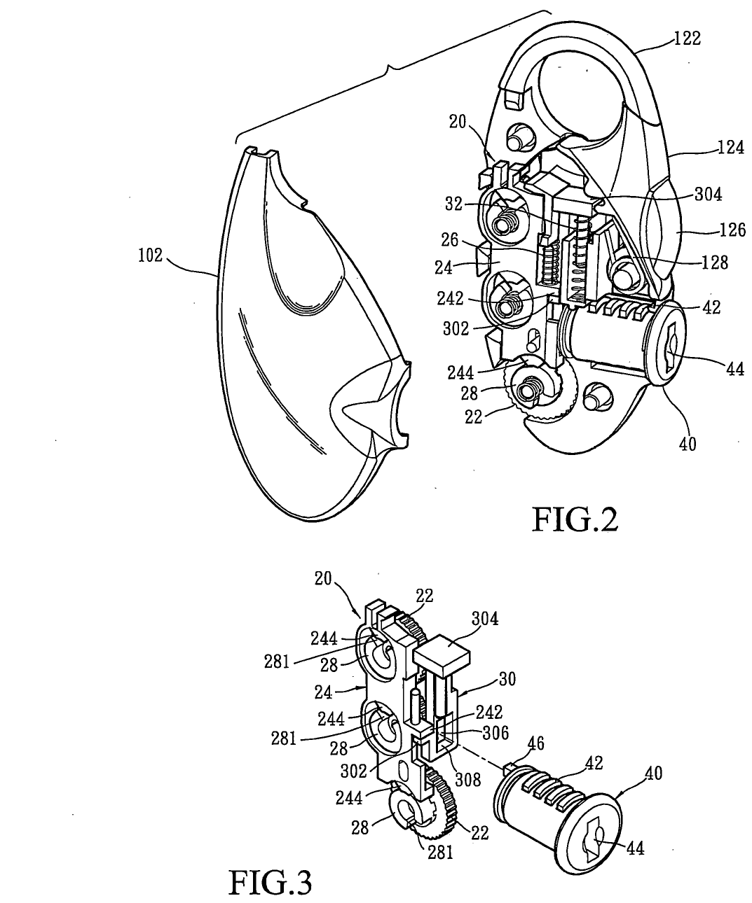

Refer to FIG. 2 for the body 10 with a side cap 102 separated, and FIG. 3 for the structure inside the padlock. The padlock includes a combination lock mechanism 20, a lock member 30 and a lock cylinder 40. The combination lock mechanism 20 includes one or more dialing wheels 22, a holding plate 24 and a second elastic element 26.

The dialing wheel 22 is pivotally coupled on the body 10. There is a cam 28 coaxially coupled with the dialing wheel and rotating therewith the rotation of the dialing wheel. The cam 28 may be coaxially fixed on the dialing wheel 22 or serve as an independent element engaged with the dialing wheel 22, and be rotated by the rotation of the dialing wheel 22. The holding plate 24 is movable and is extended outwards, to form a compression member 242, and has a latch member 244 corresponding to the cam 28. Moreover, the holding plate 24 is pushed by the second elastic element 26 to press against the dialing wheel 22, to keep the latch member 244 in contact with the cam 28, so that the holding plate 24 may be selectively at a protruding position or a contacting position according to the rotation of the cam 28.

The lock member 30 is movable and may be at a first position interfering with the movement of the movable arm 124, or at a second position without interfering with the movable arm 124, so that the movable arm 124 may be moved to form a gap on the shackle 12. The lock member 30 is pushed by a third elastic element 32, to be in contact with and pressed by the holding plate 24. The lock member 30 further is extended to form a force receiving section 302, a retaining section 304, and a thrust receiving section 306. The force receiving section 302 is pressed by the compression member 242 of the holding plate 24, so that the lock member 30 can switch position when the holding plate 24 is moving. The retaining section 304 can interfere with the movable arm 124.

The lock cylinder 40 has a plurality of latch plates 42 on the periphery and a key hole 44 to receive a matching key. Once the key is inserted into the key hole 44, the latch plates 42 extended outside the lock cylinder 40 are retracted inwards and may be driven by the key. Moreover, the lock cylinder 40 is extended to form an actuation member 46, which is an eccentric stud shaft on one end of the surface of the lock cylinder 40. And thrust receiving section 306 is a slot to receive the actuation member 46, so that the actuation member 46 can be coupled with the thrust receiving section 306.

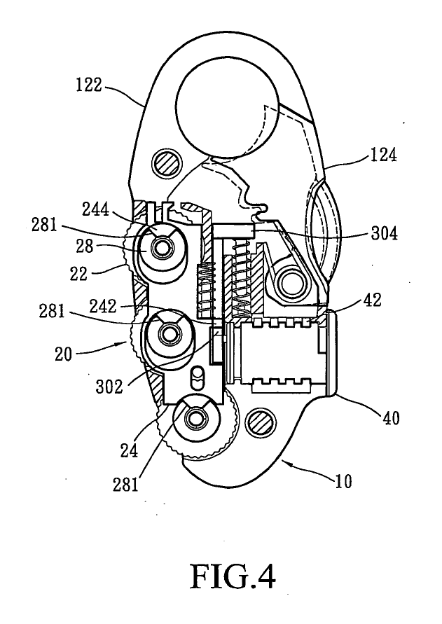

Refer to FIGS. 4 through 7 for the invention adopted for use. In FIG. 4, the cam 28 is rotated by the dialing wheel 22 to have the concave portion 281 facing the latch member 244, and the holding plate 24 is located at the contacting position as shown in the drawings, and the latch member 244 is wedged in the concave portion 281 of the cam 28. Meanwhile, the lock member 30 pressed by the holding plate 24 is moved as shown in the drawings hence the movable arm 124 is not interfered and is movable. When the movable arm 124 is pushed by an external force, it is moved relative to the fixed portion 122 to form a gap, so that the shackle 12 may be in an opened condition

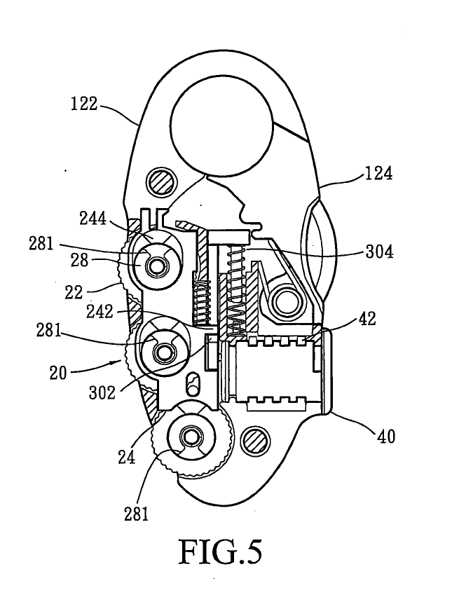

Referring to FIG. 5, when the cam is rotated by the rotation of the dialing wheel 22, and concave portion 281 of the cam 28 is not facing the latch member 224, the holding plate 24 is moved to the protruding position so that the lock member 30 is also moved to a position and is not wedged in the concave portion 281 of the cam 28. So that to the movement of the movable arm 124 is interfered. The movable arm 124 cannot be moved, not even under force, so that the shackle 12 maintains in a closed condition.

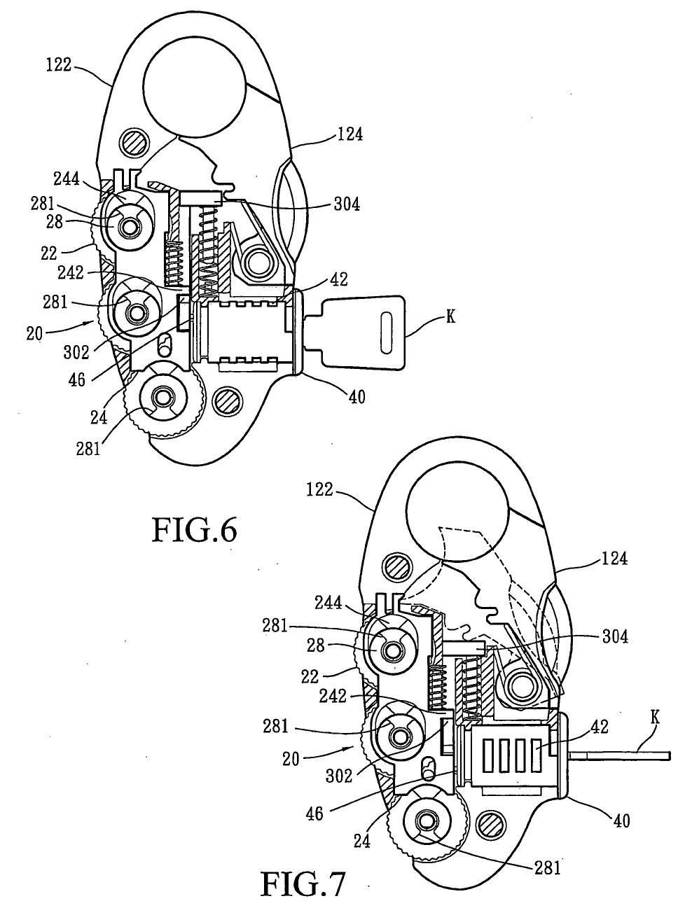

When the holding plate 24 is at the protruding position and the movement of the movable arm 124 is interfered and cannot be moved, as shown in FIG. 6, a key K may be inserted into the key hole of the lock cylinder 40, to retract the latch plates 42 of the lock cylinder 40 that are originally latched on the body 10. Then the lock cylinder 40 may be turned for 90 degrees by the key K, and the eccentric actuation member 46 is moved eccentrically to push the thrust receiving section 306, to move the lock member 30 to a position as shown in FIG. 7. Hence the movable arm 124 is moved to a position, to allow the shackle 12 to form a gap in an opened condition.

Thus interfering of the movement of the movable arm 124 by the lock member 30 can be released by setting combination through the dialing wheel 22, or by inserting and turning the key K in the lock cylinder 40.

It is to be noted that the lock cylinder 40 driving the lock member 30 by rotation is not the limitation of movement. Linear movement or a combination of rotation and linear movement may also be adopted to achieve the desired result.

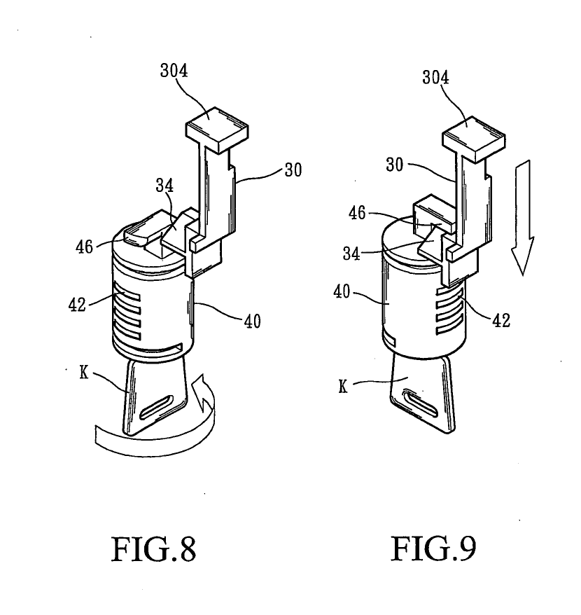

In addition, the movement relationship between the lock cylinder 40 and the lock member 30 also is not limited to what is shown in the drawings. For instance, FIGS. 8 and 9 illustrate another linkage relationship between the lock cylinder 40 and the lock member 30. The actuation member 46 of the lock cylinder 40 is the rotation center. The lock member 30 has a sloped surface 34. When the lock cylinder 40 is turned by the key K in the arrow direction shown in the drawings, the actuation member 46 continuously presses the sloped surface 34, to force the lock member 30 to move downward.

In summary, the lock mechanism of the invention can provide dual unlocking modes. When adopted on a lock, the lock may be unlocked by setting a combination or through a key, according to the user's requirements.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A padlock having dual unlocking modes, comprising:
a body having a movable arm;
at least one dialing wheel pivotally coupled on the body;
a cam rotated by the rotation of the dialing wheel;
a holding plate pressing against the dialing wheel, the holding plate being selectively at a protruding position or a contacting position according to the rotation of the cam;
an elastic element for driving the holding plate in contact with the cam;
a lock member being adapted to pressed by the holding plate, and, as the holding plate is at the protruding position, the lock member is at a first position interfering with the movement of the movable arm, and, as the holding plate is at the contacting position, the lock member is at a second position without interfering with the movement of the movable arm; and
a lock cylinder having an actuation member, wherein the cylinder is movable for driving the lock member through the actuation member driving the lock member to move between the first position and the second position.

2. The padlock having dual unlocking modes of claim 1, wherein the holding plate is extended to form a compression member and the lock member is extended to form a force receiving section to be pressed by the compression member.

3. The padlock having dual unlocking modes of claim 1, wherein the lock member is extended to form a retaining section and the retaining section can interfere with the movable arm.

4. The lock mechanism having dual unlocking modes of claim 1, wherein the lock member is extended to form a thrust receiving section coupled with the actuation member.

5. The padlock having dual unlocking modes of claim 4, wherein the actuation member is an eccentric stub shaft and the thrust receiving section is a slot to receive the eccentric stub shaft.

6. The padlock having dual unlocking modes of claim 1, wherein the lock member has a thrust receiving section with a sloped surface being pressed by the actuation member.

7. The padlock having dual unlocking modes of claim 1, wherein the lock cylinder has a key hole for a key inserting in and turning the lock cylinder.

8. The padlock having dual unlocking modes pf claim 1, further having another elastic element to push the lock member in contact with the holding plate.

9. The padlock having dual unlocking modes of claim 1, wherein the cam is an independent element engaged with the dialing wheel, and be rotated by the rotation of the dialing wheel.

10. The padlock having dual unlocking modes of claim 1, wherein the lock member is extended to form a force receiving section
